(19) United States
(12) Patent Application Publication
(10) Pub. No.: US 2005/0219721 A1
(43) Pub. Date: Oct. 6, 2005

(54) Motor vehicle with mounting location for a microphone

(76) Inventors: Klaus Linhard, Schelklingen (DE); Norbert Niemczyk, Pforzheim (DE); Christian Weiss, Krumbach (DE)

Correspondence Address: PENDORF & CUTLIFF, 5111 MEMORIAL HIGHWAY, TAMPA, FL, 33634-7356, US

(21) Appl. No.: 11/095,462

(22) Filed: Mar. 31, 2005

(30) Foreign Application Priority Data
Mar. 31, 2004 (DE) 10 2004 016 572.6
Oct. 18, 2004 (DE) 10 2004 050 953.0

(51) Int. Cl. H04M 1/00

(52) U.S. Cl. 359/838; 359/872

(57) ABSTRACT

A plug-in compartment (16) into which a microphone (18) can be plugged in a functionally capable fashion is installed in the passenger cell of a motor vehicle.

### BACKGROUND OF THE INVENTION

1. Field of the Invention

The present invention relates to a motor vehicle whose passenger cell is equipped with a microphone or which is provided for mounting a microphone.

2. Related Art of the Invention

A motor vehicle with a microphone mounted in the passenger cell is known, for example, from DE 201 08 534 U1 and from U.S. 2002/00 31 234 A1.

To be more precise, DE 201 08 534 U1 relates to a warning and display device in which, inter alia, a microphone is installed and which is provided for suspension from a conventional internal rear view mirror of the passenger cell of a motor vehicle using hooks. The microphone is intended to serve, in particular, as a hands-free microphone for a mobile phone. Since it is difficult to pass on electrical signals generated by the microphone to a mobile phone outside the warning and display device, the mobile phone is to be installed in the device itself.

This has a series of disadvantages for a user, which are associated with the fact that any mobile phone must contain, for its identification in the mobile phone network, a so-called SIM card on which data which is specific to the device and its user is stored, said data permitting the mobile phone network to recognize the device unambiguously and to invoice the user for communications costs which he has incurred. A user who does not use a mobile phone except in a motor vehicle either has to have two different SIM cards for the vehicle-supported mobile phone and for the other mobile phone which entails costs and generally also leads to the situation in which the two mobile phones of the user can be reached only via different call numbers, or the user must continuously exchange the SIM card between the different mobile phones depending on whether or not he is in the motor vehicle.

Other hands-free systems use a mount into which a mobile phone can be inserted and which is provided with an electrical plug-connector which can be connected to the mobile phone and via which an electrical voice signal which has to be transmitted by radio can be fed to the mobile phone from a hands-free microphone connected to it or a received voice signal can be output via a loudspeaker. Since the mobile phone can be removed from the mount, the problem of having to continuously change over a SIM card or use a number of SIM cards does not occur yet. However, there is the problem that when mounting such a hands-free system it would be desirable if the microphone and plug-in location for the mobile phone were contained in a common structural unit but the space necessary for this is generally not available at locations which are well suited for recording the driver's voice from the acoustic point of view. However, if the microphone and mount of the mobile phone are divided into two structural units, both must be wired to one another, which considerably increases the expenditure on the installation of such a system.

### SUMMARY OF THE INVENTION

The object of the invention is to specify a motor vehicle in which it is possible both to select an acoustically favorable installation location for the microphone and to accommodate the mobile phone at a location where there is sufficient space available for it, and with which the expenditure on the installation of the microphone is low.

The object is achieved in that a plug-in compartment for plugging in a microphone for a hands-free system in a functionally capable fashion is installed in the passenger cell of the motor vehicle according to the invention.

Such a compartment is generally equipped with plug-type contacts which permit an electrical signal which is supplied to the microphone to be passed on to a mobile phone or to some other device of the motor vehicle which processes voice signals. The mobile phone or the voice-processing device may be arranged at a location in the vehicle which is remote from the plug-in compartment and contact can be made with the necessary signal lines between this location and the plug-in compartment of the microphone with little effort when the vehicle is assembled. The plug-in compartment can be equipped with a microphone but it is also possible, for example, merely to provide it with a lid in order to retrofit a microphone only when required.

In order to be able to capture the driver's speech, the plug-in compartment is preferably arranged in the field of vision of the driver of the motor vehicle. In particular an internal roof lining of the motor vehicle, a roof operation unit, an internal rear view mirror, a dashboard or a steering wheel, may be used as spaces for accommodating the plug-in compartment.

### BRIEF DESCRIPTION OF THE DRAWINGS

Further features and advantages of the invention emerge from the following description of exemplary embodiments with respect to the appended drawings, in which:

FIG. 1 is a schematic perspective view of an internal rear view mirror holder for a motor vehicle according to the invention,

FIG. 2 shows a schematic section through the mirror holder from FIG. 1 in a plane which is parallel with its mirror,

FIG. 3 shows a section through the mirror holder in a horizontal plane,

FIG. 4 shows a schematic section through a steering wheel equipped with a plug-in location for a microphone, and

FIG. 5 shows a schematic section through a dashboard which is provided with a microphone plug-in location.

### DETAILED DESCRIPTION OF THE INVENTION

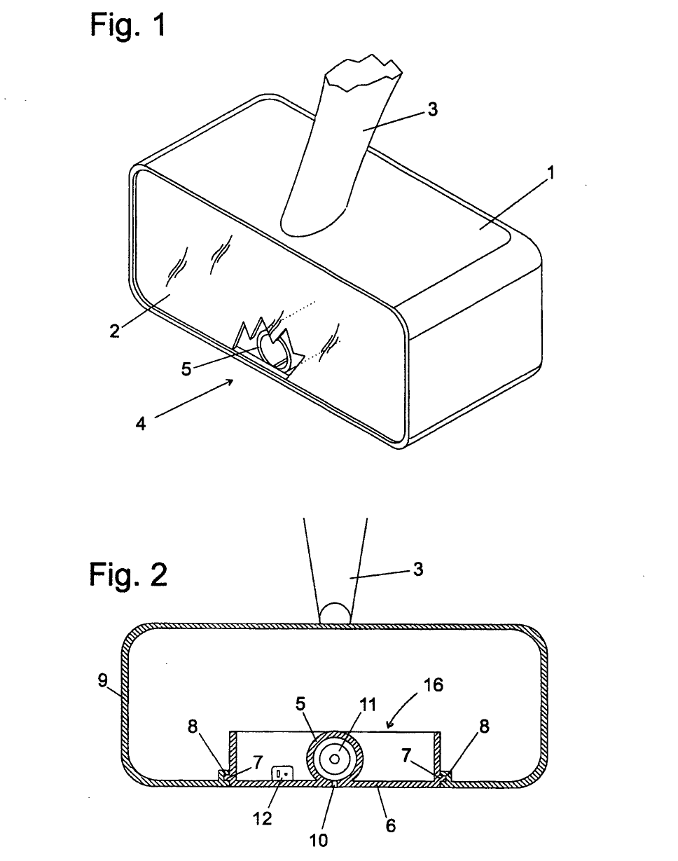

The mirror holder which is shown in a perspective view in FIG. 1 is constructed in a manner known per se from a plastic housing 1 with an approximately cuboid shape, with one side of the cube being formed by a mirror 2 which is let into the housing. A supporting arm 3, whose other end (not illustrated) is mounted in the passenger cell of a motor vehicle, for example, bonded onto the inside of its windshield or screwed to the internal roof lining in the vicinity of its front edge or attached in some other way engages on the upper side of the housing 1.

The mirror housing 1 which is shown in FIG. 1 is characterized by a considerable depth which is considerably greater than is necessary only for securely holding the mirror 2. What is referred to as an interference tube microphone 4 is accommodated in the interior of this housing. If the mirror 2 is viewed directly in a perpendicular fashion or from the customary direction of a driver of the vehicle who wishes to observe the traffic behind, the interference tube microphone 4 is concealed completely behind the mirror 2. In FIG. 1, the mirror 2 is illustrated in a partially broken-open fashion in order to be able to show the microphone 4.

As is apparent in particular in FIG. 2, the interference tube 5 of the microphone 4 which is oriented perpendicularly with respect to the surface of the mirror 2 and to the sectional plane of this figure is embodied in one piece with a part 6 of the housing 1 which is in the shape of a flat box or a drawer which, with the aid of protruding ribs 7 which engage in matching grooves 8 on another part 9 of the housing 1, can be displaced in a plug-in compartment 16 on the underside of the housing part 9 in a direction which is perpendicular to the mirror surface and can be pulled out of the housing part 9 on its side facing away from the mirror 2. The underside of the housing part 6 is flush with the surrounding underside of the housing part 9. A slot 10 which extends in the longitudinal direction of the interference tube 5 or a multiplicity of successive openings in the longitudinal direction of the interference tube 5 connect its interior to the surroundings and permit sound to enter the interference tube 5 so that it finally reaches a microphone capsule 11 which is mounted on an end wall of the interference tube 5 facing away from the mirror 2.

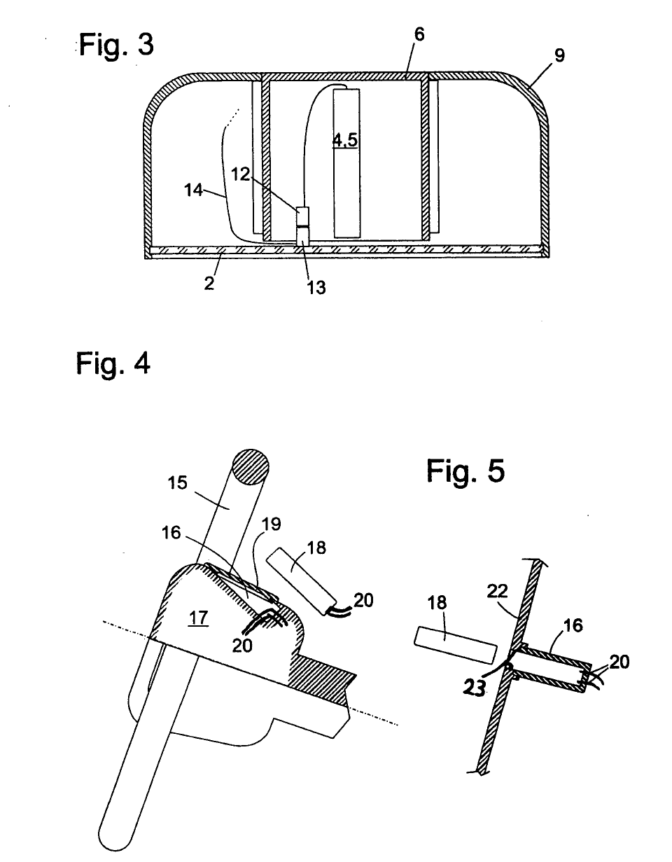

Electrical connections of the microphone capsule 11 are connected to a plug-type connector 12 which is oriented in the displacement direction of the housing part 6 and a plug-in type connector 13 (cf. FIG. 3) which is complementary thereto is mounted on the rear of the mirror 2 so that both make contact with one another when the housing part 6 is inserted into the housing part 9 as far as the stop. The electrical signal of the microphone is conducted away for further processing via the pair of plug-type connectors 12, 13 and cables 14 which run through the supporting arm 3.

The end side of the interference tube 5 lying opposite the microphone capsule 11 is generally closed off by the mirror 2. However, if it proves acoustically expedient it is also possible to provide a small bore in the mirror 2 as an extension of the interference tube 5 in order to permit sound to enter directly through this bore in the longitudinal direction of the interference tube.

Instead of a single microphone 4 it is also possible to arrange a plurality of microphones one next to the other with connected signal outputs in the housing part 6 in order to implement a directional characteristic of the multiplicity of microphones which deviate from the directional characteristic of a single microphone. It is also possible, in contrast to the orientation of the microphone 4 which is parallel to the plug-in direction, to use an arrangement in which at least one microphone is oriented with its interference tube toward the driver and a further one toward the front seat passenger.

In the case of a user who does not desire an installed microphone in his vehicle it is possible to use a housing part in the form of a simple empty box instead of the housing part 6 which is equipped with a microphone. The plug-in type connector 13 and the cable 14 which leaves it and which leads via a cable harness to the plug-in location for a mobile phone or a location in the passenger cell which is provided for the mounting of such a plug-in location is nevertheless already installed in such a vehicle when it is supplied in order to facilitate retrofitting of the hands-free function by simply replacing the empty housing part 6 with one with at least one microphone 4.

A second refinement of the invention is shown in FIG. 4. This figure shows a motor vehicle steering wheel 15 partially in a side view and partially in section. In the sectional upper half of the steering wheel 15 it is possible to see a plug-in compartment 16 which runs from the upper part of the steering wheel hub 17 obliquely into its interior. The orientation of the plug-in compartment 16 is defined in such a way that a microphone 18 which engages in the plug-in compartment 16 in a positively engaging fashion has its maximum sensitivity in one spatial direction in which the driver's head is normally located. Furthermore, the arrangement of the plug-in compartment 16 on the side of the steering wheel hub 17 has the advantage that sufficient space for an airbag is available in its interior.

FIG. 4 illustrates the plug-in compartment 16 with a lid 19 which closes it and is fitted on, and a user can remove the lid 19 where necessary and instead insert the microphone 18 which is matched precisely to the plug-in compartment 16 in terms of its dimensions. For example, plug-type connectors 20 on the rear of the microphone 18 and on the bottom of the plug-in compartment 16 make contact with one another in order to derive the electrical signal which is sensed by the microphone 18.

The microphone 18 may be an interference tube microphone like the microphone 4 in FIGS. 1 to 3, because a large part of its side wall remains free when it is plugged in to the plug-in compartment 16 and one or more sound inlet openings may be formed on this freely exposed part. However, since the end side of the microphone is also exposed here and faces the speaker or driver, any other types of microphone in which a microphone capsule or a sound inlet opening is located at the end side are also possible.

FIG. 5 shows a schematic section through a dashboard 22 of a motor vehicle according to the invention. A plug-in compartment 16 of beaker-like shape is arranged on the rear side of an opening 23 of the dashboard 22. In the embodiment in FIG. 5, the plug-in compartment 16 is latched to the rear side of the dashboard 22 but other shapes of connection between the plug-in compartment 16 and dashboard 22 are also possible, including a single-part shape of the two parts of the connection. As in FIG. 4, the plug-in compartment is provided on its bottom with plug-type connectors 20 which are used to derive the electrical voice signal which is supplied by a microphone 18 which is inserted into the plug-in compartment.

A plug-in location for receiving a mobile phone to which the voice signal which is captured by the microphone 18 is fed can be provided at virtually any desired location in the passenger compartment, for example on a center console (not illustrated). The required wiring between the plug-in compartment 16 and the plug-in location of the mobile phone is expediently also installed on a series-production basis when the vehicle is assembled, irrespective of whether or not a microphone is able to be installed, and runs via the same cable harnesses via which, for example, in the embodiment in FIGS. 1 to 3, a power supply for a passenger compartment lighting system which is mounted in the internal roof lining of the vehicle are guided, or in FIG. 4 switching signal lines from control switches, also mounted on the steering wheel, for flashing indicator lights and windshield wipers are routed, or in FIG. 5 display signal lines from display instruments which are arranged on the dashboard next to the plug-in compartment 16 are routed.

1. A motor vehicle having a passenger cell, wherein a plug-in compartment (16) for plugging in a microphone (4, 18) in a functionally capable fashion is installed in the passenger cell.

2. The motor vehicle as claimed in claim 1, wherein the plug-in compartment (16) is closed off with a lid (19).

3. The motor vehicle as claimed in claim 1, wherein the plug-in compartment (16) is equipped with a microphone (4, 18).

4. The motor vehicle as claimed in claim 1, wherein the plug-in compartment (16) is arranged in the field of vision of the driver of the motor vehicle.

5. The motor vehicle as claimed in claim 1, wherein the plug-in compartment (16) is arranged at a location which is selected under an internal roof lining of the motor vehicle, a roof operation unit, an internal rear view mirror (1), a dashboard (22) or a steering wheel (15).

6. The motor vehicle as claimed in claim 1, wherein plug-in contacts (20) are directed towards a bottom of the plug-in compartment (16) in the plug-in direction.
